(19) United States
(12) Patent Application Publication
(10) Pub. No.: US 2008/0141860 A1
(43) Pub. Date: Jun. 19, 2008

(54) PROCESS FOR INCREASING HYDROGEN RECOVERY

(76) Inventor: Edward R. Morgan, Elk Grove Village, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/612,340

(22) Filed: Dec. 18, 2006

(51) Int. Cl. B01D 53/047

(52) U.S. Cl. 95/96

(57) ABSTRACT

A process for increasing hydrogen recovery can include:
(a) sending a first gas from a hydrocarbon conversion zone at a first pressure to a hydrogen purification zone;
(b) combining a second gas from a particle transport vessel at a second pressure less than the first pressure with a tail gas from the hydrogen purification zone to create a combined stream; and
(c) recycling at least a portion of the combined stream to an inlet of the hydrogen purification zone.

### FIELD OF THE INVENTION

The field of this invention is a process for increasing the recovery of hydrogen.

### BACKGROUND OF THE INVENTION

Hydrocarbon conversion processes that are exothermic or endothermic can be employed in the petroleum refining or petrochemical production industry. An exemplary hydrocarbon conversion process for improving the octane quality of hydrocarbon feedstocks is catalytic reforming where the primary product of reforming being motor gasoline or a source of aromatics for petrochemicals. The art of catalytic reforming is well known.

Generally, there has been an impetus for developing reforming processes that produce a higher purity gasoline with fewer pollutants to meet environmental standards. One such pollutant is sulfur. As an example, to remove sulfur from gasoline, refineries can treat hydrocarbon streams with hydrogen to convert the elemental sulfur to a gaseous compound, such as hydrogen sulfide, that can be separated from a hydrocarbon stream that is subsequently converted into gasoline. This removal permits creating a fuel with low sulfur content.

Consequently, there has been a corresponding demand for hydrogen to treat such hydrocarbon streams. Generally, it is economical to recover the hydrogen from various units and vessels within the refinery or petrochemical production facility for treating the hydrocarbon streams. As demand for hydrogen grows, process streams containing small volumes and even low purities of hydrogen are viewed as potential sources of hydrogen for use within the refinery or petrochemical production facility.

One such hydrogen stream is the vent gas from a particle transport vessel used in conjunction with a catalyst regeneration unit. Particularly, the vent gas from such a vessel can be routed back to a hydrocarbon conversion unit. However, some hydrocarbon conversion units operate at higher pressure than the particle transport vessel. Thus, this vent gas cannot be routed to the hydrocarbon conversion unit unless fluid transport equipment is installed, such as a pump or compressor. Typically, the amount of mass flow in such vessel vent gas streams do not justify economically the purchase and installation of such equipment. In addition, often these vent gas streams have impurities. Such impurities can lead to undesirable side reactions in the hydrocarbon conversion unit. Thus, it would be beneficial if such streams could be processed and recovered for use in, e.g., a hydrocarbon conversion unit. So, there is a desire to recover such hydrogen in the vent streams and utilize them at different units within the refinery or petrochemical production facility, even those at pressures greater than the sources of hydrogen.

### BRIEF SUMMARY OF THE INVENTION

An exemplary process for increasing hydrogen recovery can include sending a first gas from a hydrocarbon conversion zone at a first pressure to a hydrogen purification zone, combining a second gas from a particle transport vessel at a second pressure less than the first pressure with a tail gas from the hydrogen purification zone to create a combined stream, and recycling at least a portion of the combined stream to an inlet of the hydrogen purification zone.

A further exemplary process for recycling a tail gas from a hydrogen purification zone generally includes passing the tail gas to a first stage of a compressor and sending the gas from the drum to the second stage of the compressor. Generally, at least a portion of the tail gas is discharged to a drum to remove one or more liquid fractions and at least a portion of the tail gas is purged as fuel gas and another portion is recycled to an inlet of a hydrocarbon purification zone.

Yet a further exemplary process for increasing hydrogen recovery may include sending a transport gas from a vessel at a pressure that is less than a pressure of a hydrocarbon conversion zone to a tail gas from a hydrogen purification zone for recycling at least a portion of the gas to the hydrogen purification zone.

As a consequence, the present invention allows the recovery of hydrogen from sources that are at a lesser pressure than those at other units, such as a hydrocarbon conversion zone. Thus, the embodiments disclosed herein allow the recovery of hydrogen that might otherwise be sent to fuel gas. In particular, unrecovered hydrogen streams are generally sent to the fuel gas, which is typically a lower valued product than if recovered and purified. What is more, the embodiments disclosed herein permit the modification of any existing hydrocarbon conversion unit to recover a hydrogen gas stream without the additional expense of equipment such as a compressor.

### BRIEF DESCRIPTION OF THE DRAWING

FIG. 1 is a schematic depiction of one exemplary embodiment of a refinery or a petrochemical production facility.

### DEFINITIONS

As used herein, the term “hydrocarbon stream” can be a stream including various hydrocarbon molecules, such as straight-chain, branched, or cyclic alkanes, alkenes, alkadienes, and alkynes, and optionally other substances, such as gases, e.g., hydrogen, or impurities, such as heavy metals. The hydrocarbon stream may be subject to reactions, e.g., reforming reactions, but still may be referred to as a hydrocarbon stream, as long as at least some hydrocarbons are present in the stream after the reaction. Thus, the hydrocarbon stream may include streams that are subjected to, e.g., a hydrocarbon stream effluent, or not subjected to, e.g., a naphtha feed, one or more reactions. As used herein, a hydrocarbon stream can also include a raw hydrocarbon feedstock, a hydrocarbon feedstock, a feed, a feed stream, a combined feed stream or an effluent. Moreover, the hydrocarbon molecules may be abbreviated C₁, C₂, C₃ . . . Cₙ where “n” represents the number of carbon atoms in the hydrocarbon molecule.

As used herein, the term “zone” can refer to an area including one or more equipment items and/or one or more sub-zones. Additionally, an equipment item, such as a reactor or vessel, can further include one or more zones or sub-zones.

### DETAILED DESCRIPTION OF THE INVENTION

The embodiments disclosed herein allow a gas (hereinafter may be referred to as a “second gas”) containing hydrogen at a pressure lower than a hydrocarbon conversion zone to be recycled in a tail gas recycle circuit that can include a hydrogen purification zone. Generally, the hydrogen purification zone receives a gas (hereinafter may be referred to as a “first gas”) containing hydrogen from a hydrocarbon conversion zone where typically a hydrogen product stream can be at least partially recycled back to the hydrocarbon conversion zone while producing a tail gas that is at least partially recycled. The second gas can be combined with the tail gas to be recycled back to the hydrogen purification zone where at least a portion is recovered as the hydrogen product stream, and as mentioned above, sent back to the hydrocarbon conversion zone.

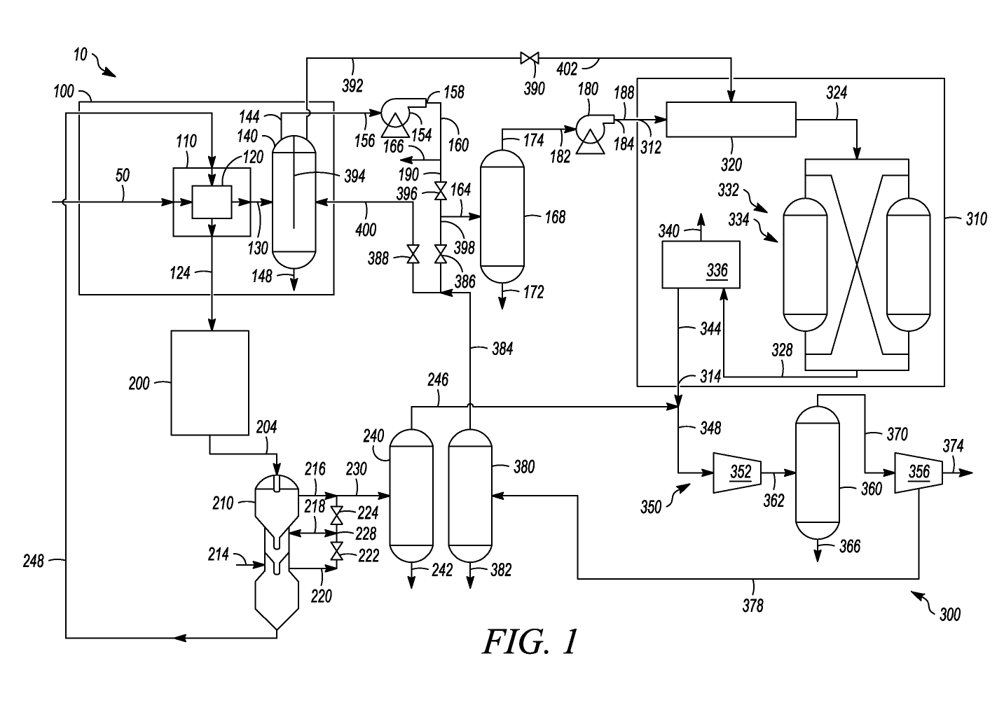

Referring to FIG. 1, a refinery or a petrochemical production facility 10 can include a hydrocarbon conversion zone 100, a catalyst regeneration zone 200, a particle transport vessel 210 and a tail gas recycle circuit 300. Generally, the hydrocarbon conversion zone 100 can include at least one reaction zone 110 and a separator 140. Generally the at least one reaction zone 110 can include at least one moving bed 120 arranged in a stacked reactor or a side-by-side reactor configuration and include a plurality of reaction zones or sub-zones. Processes having multiple reaction zones may include a wide variety of hydrocarbon conversion processes such as reforming, alkylating, dealkylating, hydrogenating, hydrotreating, dehydrogenating, isomerizing, dehydroisomerizing, dehydrocyclizing, cracking, or hydrocracking. Catalytic reforming often utilizes multiple reaction zones, and may be referenced hereinafter.

Preferably, the hydrocarbon conversion zone 100 is a reforming reaction zone. Such zones are disclosed in, for example, U.S. Pat. Nos. 4,119,526 (Peters et al.) and 4,409,095 (Peters). Various reactions can take place during catalytic reforming. Generally, the catalyst bed temperatures are about 260-about 566° C. (about 500-about 1,050° F.) and can be operated at a pressure of about 440-about 7,000 kPa(a) (about 65-about 1,000 psi(a)). Generally, the hydrocarbon conversion zone 100 in this embodiment operates at a pressure above about 450 kPa(a) (about 65 psi(a)), such as a pressure of about 450-about 650 kPa(a) (about 65-about 95 psi(a)).

The hydrocarbon stream can enter in a line 50 to undergo reforming reactions to exit the at least one reaction zone 110 as a reaction zone effluent through a line 130 to a separator 140. The reaction zone effluent contains light gasses, such as methane, ethane and hydrogen, that are separated from the reformate product in the separator 140. Typically, the reformate exits through a line 148 and the light gasses exit through a line 144 to exit the hydrocarbon conversion zone 100. Generally, these light gases can be referred to as a separator vent gas and typically have a purity of at least about 75%, at least about 83%, by volume, hydrogen.

Generally, the separator vent gas travels through a line 144 to a suction 156 of a compressor 154, which can be a recycle compressor. Typically, valves 388 and 390 are closed. Generally, the gas exits a discharge 158 of the compressor 154 and travels through a line 160. A portion can be sent through a line 166 to the at least one reaction zone 110 and another portion through a line 190, a valve 396, and then a line 164 to a drum 168. The flow of gas through a line 398, as described hereinafter, can be merged with the separator vent gas from the line 190 in the line 164 to form a merged stream. In the drum 168, the heavier materials can exit through a line 172 and be routed back to, desirably, the separator 140 or mixed in the line 148.

The lighter material may exit through a line 174 to a suction 182 of a compressor 180, such as a net gas compressor. Generally, the net compressor 180 may include one or more stages. Subsequently, the gas can exit a discharge 184 of the net compressor 180 and travel through a line 188 to the hydrogen purification zone 310, having an inlet 312 and an outlet 314. The hydrogen purification zone 310 can be part of a tail gas recycle circuit 300.

The tail gas recycle circuit 300 can include the hydrogen purification zone 310, a first and second stage tail gas compressor 350, a drum 360, a drum 380, the drum 168, and the net gas compressor 180.

Generally, the hydrocarbon purification zone 310 can include a recontact zone 320, a chloride adsorption zone 332, and a pressure swing adsorber 336. The recontact zone 320, the chloride adsorption zone 332 and the pressure swing adsorber 336 are known to those skilled in the art and exemplary vessels are disclosed in U.S. Pat. No. 5,332,492 (Maurer et al.). The recontact zone 320 may include several recontact drums which are sequentially arranged and pre-cooled with a liquid product providing enough of a temperature reduction to produce favorable equilibrium conditions to reduce a content of liquefiable hydrocarbons in the merged gas stream. This recontact zone can increase the purity of the hydrogen in the gas exiting the zone 320 up to about 82%, even up to about 94%, by volume, hydrogen.

Afterwards, the gas typically enters a line 324 to the chloride adsorption zone 332, which can include a plurality of adsorbers 334 in swing mode operation. The chloride adsorption zone 332 adsorbs chloride-containing compounds. Any suitable adsorbent may be used, such as alumina, a silica gel, silica-alumina beads, and molecular sieves. The gas can exit the chloride adsorption zone 332 at a purity of up to about 82%, even up to about 94%, by volume, hydrogen.

Subsequently, the gas can exit through a line 328 to the pressure swing adsorber 336. Suitable adsorbents for the pressure swing adsorber can include crystalline molecular sieves, activated carbons, activated clays, silica gels, activated aluminas, and combinations thereof. Generally, the pressure swing adsorber 336 produces a high purity hydrogen stream through a line 340 and a tail gas stream through a line 344. The pressure swing adsorber can produce a hydrogen stream in the line 340 having a purity ranging from about 95.0-about 99.99%, by volume, hydrogen at a pressure of about 345-about 3,800 kPa(a) (about 50-about 550 psi(a)).

The tail gas stream in the line 344 can have a hydrogen purity of about 10%, by volume, at a pressure of about 35-about 550 kPa(a) (about 5-about 80-psi(a)) and exit the hydrogen purification zone 310 at the outlet 314. The rest of the tail gas recycle circuit 300 is described after the following description of the lock-hopper vent gas in a line 246 is discussed.

Referring to the hydrocarbon conversion zone 100, generally the at least one reaction zone 110 utilizes a catalyst to conduct the reforming reactions. The catalyst can travel through the at least one reaction zone 110 and exit through a lift conduit 124 to a catalyst regeneration zone 200.

Typically, the catalyst undergoes several regeneration steps, including combustion, dispersion, drying and cooling. Such catalyst regeneration zones are disclosed in U.S. Pat. No. 5,837,636 (Sechrist et al.).

The catalyst may exit the catalyst regeneration zone 200 through a line 204 to enter a vessel or particulate transport vessel 210. An exemplary particulate transport vessel 210 can include a lock-hopper. Exemplary lock-hoppers are disclosed in U.S. Pat. Nos. 4,576,712 (Greenwood), and 4,872,969 (Sechrist). Typically, the lock-hopper acts as a store for receiving regenerated catalyst from the catalyst regeneration zone 200 and adding such catalyst to the hydrocarbon conversion zone 100 as required. The catalyst from the particle transport vessel 210 can travel back to the hydrocarbon conversion zone 100 through a lift conduit 248.

The atmosphere in the lock-hopper can include a buffering atmosphere of nitrogen in the line 204 and upper portions of the particulate transport vessel 210 with a transport gas, such as hydrogen, added in a line 214. As a result, gas flow rates and pressures can be controlled by the various lines 216, 218, 220 and 228 and valves 222 and 224 to regulate the release of catalyst from the vessel 210. Excess gas can be vented through a line 230. Typically, such a lock-hopper vent gas can have hydrogen levels of at least about 80%, even up to about 99.99%, by volume.

The pressure in the vessel 210 (and correspondingly the line 230) can exceed the pressure in the line 344, but not the separator 140. Generally, the vessel 210 is operated at a pressure of about 0-about 550 kPa(a) (about 0-about 80 psi(a)), desirably about 330-about 350 kPa(a) (about 49-about 51 psi(a)).

The lock-hopper vent gas can travel to a drum 240. Desirably, the drum 240 provides a sufficient surge volume to maintain sufficient back pressure on the vessel 210. In the drum 240, heavier materials, such as liquids, can exit through a line 242 to, e.g., a relief header. Generally, the gas, which includes hydrogen, can travel through the line 246 to be combined with the tail gas in the line 344 in a line 348. Due to the gas in the line 246 being, typically, at least about 10 times less than the amount of tail gas in the line 344, existing equipment can be utilized for processing the combined stream, as discussed below.

Generally, the combined gas is compressed in the two-stage compressor 350, having a first stage 352 and a second stage 356. After the first stage 352, the gas travels in a line 362 to a drum 360 where one or more liquid fractions can exit through a line 366 to, e.g., a relief header, and the gaseous portions 370 can travel to the second stage 356. Subsequently, a portion of the tail gas can be purged, i.e. purged tail gas, through a line 374 for use as fuel gas with the balance of the tail gas traveling through a line 378 to a drum 380 for recycling. Generally, the gas in the line 374 can include about 30%-about 70%, by volume, of the combined stream in the line 348. In addition, other compressors and/or arrangements may be used instead. As an example, the compressor may be a screw-type rotary, centrifugal, or reciprocating compressor. Furthermore, the compressor can have any number of stages, and can have various schemes, such as spillback and intercooling features. The drums 360 and 380 may not be required in some embodiments.

In the drum, a liquid portion can exit through a line 382 and be used, for example, in the recontact zone 320. The gas can then travel through a line 384 past a valve 386 into a line 164, where it is combined with the separator vent gas in the line 190. Afterwards, the merged stream can enter the drum 168.

In another exemplary embodiment, the valves 386 and 396 can be closed and the valves 388 and 390 can be opened. Although this alternative scheme is depicted along with the first scheme, it should be understood that these schemes can be used independently of one another. As an example, this scheme may exclude certain vessels such as the drum 168 and the net gas recycle compressor 180.

In this scheme, the combined stream of lock-hopper vent gas and tail gas in the line 384 may be routed through the valve 388 and a line 400 to the separator 140. In this exemplary embodiment, the separator 140 can have a partition 394 to prevent gas from pressuring back through the line 130 to at least one reaction zone 110. In the separator 140, the gas can exit through a line 392, the valve 390, and a line 402 to the recontact zone 320 in the hydrogen purification zone 310. Optionally, a compressor in the hydrogen purification zone 310 can withdraw gas from the separator 140.

The embodiments present herein can permit the recovery of gas streams without the purchase of additional equipment, such as a compressor, particularly if such a modification is made to an existing process unit. As an example, the first gas stream (separator vent gas) in the line 144 can be about 180,000 kg/hr (about 390,000 lb/hr) at a temperature of about 46° C. (about 120° F.) and a pressure of about 660 kPa(a) (about 95 psi(a)) and in the lines 190 or 392 can be about 82,000 kg/hr (180,000 lbs/hr) at a temperature of about 88° C. (about 190° F.). The mass flow rate of the second gas (lock-hopper vent gas) in the line 230 can be about 630 kg/hr (about 1,400 lbs/hr) at a temperature of about 200° C. (about 400° F.) and a pressure of about 140 kPa(a) (about 20 psi(a)). Thus, the mass flow rate of the first gas stream can be at least about 10 times greater, or even about 100 times greater, than the mass flow rate of the second gas stream. Therefore, the added second gas stream can be processed by existing equipment if such a modification is made to a refinery or petrochemical facility. As a further example, the tail gas can have a mass flow of 15,000 kg/hr (about 32,000 lbs/hr) at a temperature of about 43° C. (about 110° F.), which is at least more than 10 times, even more than about 20 times, greater than the second gas flow rate. Again, this demonstrates the feasibility of recovering a relatively small gas stream without having to purchase additional equipment, such as a compressor. The embodiments discussed herein can be particularly suited for modifying an existing refinery or petrochemical production facility to recover hydrogen from various production streams.

Generally, it is believed that the present embodiments can recover up to about 50%, or even about 70%, by volume, of the hydrogen from the particulate transport vessel 210 without using an extra piece of equipment, such as a compressor. Although vent gas from a particle transport vessel has been described as being recovered, it should be understood that vent gas streams containing hydrogen having a pressure less than a hydrocarbon conversion zone, but greater than a pressure swing adsorber tail gas outlet, can similarly be recovered.

Thus, these embodiments allow the recycling of vent gas from a particle transport vessel, when, for example, the pressure in the hydrocarbon conversion zone exceeds that of the particle transport vessel 210. Although the vent gasses from the particle transport vessel are being routed to a relatively low pressure line exiting the hydrogen purification zone 310, it should be understood that in another exemplary embodiment, a compressor could be used to pressurize the gas from the particle transport vessel 210 to the hydrocarbon conversion zone 100.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth uncorrected in degrees Celsius and, all parts and percentages are by volume, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. A process for increasing hydrogen recovery, comprising:
(a) sending a first gas from a hydrocarbon conversion zone at a first pressure to a hydrogen purification zone;
(b) combining a second gas from a particle transport vessel at a second pressure less than the first pressure with a tail gas from the hydrogen purification zone to create a combined stream; and
(c) recycling at least a portion of the combined stream to an inlet of the hydrogen purification zone.

2. A process according to claim 1, wherein the hydrogen purification zone comprises a pressure swing adsorber.

3. A process according to claim 1, wherein the hydrocarbon conversion zone comprises at least one reaction zone and a separator, and the first pressure is at least about 450 kPa(a) and the first gas is withdrawn from the separator.

4. A process according to claim 1, wherein the second gas comprises at least about 80%, by volume, hydrogen.

5. A process according to claim 4, wherein the particle transport vessel is a lock-hopper for a regenerated catalyst.

6. A process according to claim 1, wherein a mass flow of the first gas is at least about ten times greater than a mass flow of the second gas.

7. A process according to claim 1, wherein the mass flow of the first gas is at least about one-hundred times greater than the mass flow of the second gas.

8. A process according to claim 1, wherein the second pressure is no more than about 550 kPa(a).

9. A process according to claim 1, wherein the second pressure is about 35-about 550 kPa(a).

10. A process according to claim 2, wherein the hydrogen purification zone further comprises a chloride adsorber.

11. A process according to claim 1, wherein the first gas comprises at least 75%, by volume, of hydrogen.

12. A process according to claim 1, wherein an inlet gas of a pressure swing adsorber comprised in the hydrogen purification zone has a purity of at least 82%, by volume, of hydrogen.

13. A process according to claim 3, wherein the hydrocarbon conversion zone is a reforming zone.

14. A process according to claim 13, wherein the reforming zone comprises at least one moving bed.

15. A process according to claim 14, further comprising transporting the at least one moving bed catalyst to the regeneration zone.

16. A process according to claim 1, wherein the hydrogen purification zone produces a product stream comprising at least about 95%, by volume, of hydrogen.

17. A process for recycling a tail gas from a hydrogen purification zone, comprising:
a) passing the tail gas to a first stage of a compressor, wherein at least a portion of the tail gas is discharged to a drum to remove one or more liquid fractions; and
b) sending the gas from the drum to the second stage of the compressor, wherein at least a portion of the tail gas is purged for fuel gas and another portion is recycled to an inlet of a hydrocarbon purification zone.

18. A process according to claim 17, further comprising a tail gas recycle circuit comprising the hydrogen purification zone, the first and second stage tail gas compressor, a plurality of drums, and another compressor.

19. A process for increasing hydrogen recovery, comprising:
(a) sending a transport gas from a vessel at a pressure that is less than a pressure of a hydrocarbon conversion zone to a tail gas from a hydrogen purification zone for recycling at least a portion of the transport gas to the hydrogen purification zone.

20. A process according to claim 19, wherein the catalyst regeneration zone regenerates catalyst for a reforming zone comprising at least one moving bed that operates at a pressure of at least about 450 kPa(a) and the vessel comprises a particle transport vessel.
